(19) United States
(12) Patent Application Publication
(10) Pub. No.: US 2026/0098182 A1
(43) Pub. Date: Apr. 9, 2026

(54) COATING COMPOSITIONS WITH POLYOLEFIN NETWORK STRUCTURE

(71) Applicant: SWIMC LLC, Cleveland, OH (US)

(72) Inventors: Ilhan ULKEM, University Heights, OH (US); Jeremy DAUM, Brecksville, OH (US); Stephanie MAGNANI, Berea, OH (US); Andrew C. RECKER, Avon, OH (US)

(21) Appl. No.: 19/115,058

(22) PCT Filed: Sep. 25, 2023
(86) PCT No.: PCT/US2023/075012

§ 371 Date: Mar. 25, 2025

Related U.S. Application Data
(60) Provisional application No. 63/377,127, filed on Sep. 26, 2022.

(51) Int. Cl. C09D 165/00; B05D 1/02; C09D 4/00; C09D 5/08; C09D 7/20; C09D 7/61

(52) U.S. Cl. CPC C09D 165/00; B05D 1/02; C09D 4/00; C09D 5/08; C09D 7/20; C09D 7/61; B05D 2518/00; B05D 2601/20

(57) ABSTRACT

An insulative coating system is described herein. The coating system includes a ring-opening metathesis polymer (ROMP) component and fillers selected to provide sufficient to provide a thermal insulative Monomers of the ROMP component are selected to provide optimal Tg, insulative properties, and performance characteristics. Methods to make and apply the insulative coating system to a substrate are also described.

### BACKGROUND OF THE INVENTION

Coating compositions are applied to a variety of substrates for a variety of uses, and may be used for both protective and aesthetic purposes. Such coatings need to be applied quickly and efficiently.

Two-component (2K) crosslinked coatings are often used as protective and/or insulative coatings. A key challenge with such coatings is balancing cure properties with potlife, open time, work time, etc. This is particularly true for high solids coating systems. Coatings for application as protective coatings and/or insulative coatings often require longer potlife to allow the coating to be applied to a substrate in an effective and practical manner. The viscosity and low solvent content requirements for high solids systems force selection of low molecular weight and/or lower glass transition temperatures (Tg) resins that will require larger amounts of crosslinker. This may also lead to the presence of significant unreacted byproducts in the resin system, contributing to coating performance defects, increased volatile organic content (VOC), as well as coating toxicity. In general, for high solids systems, a combination of fast drying and optimal performance is challenging to achieve.

Ring-opening metathesis polymer (ROMP) polymer systems offer a different approach to achieving an advantageous polymer network that may be used in a high solids system while achieving appropriate potlife and cure performance. By selecting particular monomers, mix ratios, and catalyst components, it is possible to use a ROMP polymer system to achieve a low viscosity base for a 100% solids coating systems. Currently, ROMP systems have not been widely used to make protective and/or insulative coating systems. Proper catalyst selection as well as problems with sprayability have impeded the use of these systems in protective coatings.

From the foregoing, it will be appreciated that what is needed is a protective and insulative high solids coating system based on ROMP components that is sprayable, demonstrates fast cure and has optimal performance characteristics.

### SUMMARY

The present description provides a coating composition or coating system for use in and as high performance insulative and/or protective coating system. The coating composition is a high solids liquid coating that may be applied to a variety of substrates, including metal and non-metal materials, and the coating is preferably applied by spraying.

In one embodiment, the insulative and/or protective coating system described herein includes a ring-opening metathesis polymerization (ROMP) component that includes a combination of cyclic olefins having one or more multi-unsaturated groups and cyclic olefins having at least one mono-unsaturated group. The system further includes at least one metal carbene ROMP catalyst that is a transition metal complex, and also includes a thermal insulative filler dispersed within the ROMP component.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### SELECTED DEFINITIONS

Unless otherwise indicated, the term “polymer” includes both homopolymers and copolymers (i.e., polymers of two or more different monomers).

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). Organic groups as described herein may be monovalent, divalent or polyvalent. The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group.

The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “Ar” refers to a divalent aryl group (i.e., an arylene group), which refers to a closed aromatic ring or ring system such as phenylene, naphthylene, biphenylene, fluorenylene, and indenyl, as well as heteroarylene groups (i.e., a closed ring hydrocarbon in which one or more of the atoms in the ring is an element other than carbon (e.g., nitrogen, oxygen, sulfur, etc.)).

The terms “alkenyl group” and “alkynyl group” may both be referred to independently as “unsaturated” groups. The term “mono-unsaturated” as used herein means a group or moiety that has one unsaturated group. The term “multi-unsaturated” as used herein means a group or moiety is at least bifunctional, i.e. has at least two unsaturated groups, and may include more than two unsaturated groups.

Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “heteroarylene” groups (e.g., furylene, pyridylene, etc.).

Substitution is anticipated on the organic groups of the compounds of the present invention. When the term “group” is used herein to describe a chemical substituent, the described chemical material includes the unsubstituted group and that group with O, N, Si, or S atoms, for example, in the chain (as in an alkoxy group) as well as carbonyl groups or other conventional substitution. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc.

The term “crosslinker” refers to a molecule capable of forming a covalent linkage between polymers or between two different regions of the same polymer. The term “crosslinker,” as used herein, is interchangeable with “hardener.” The term “curing agent” refers to a component that includes both (or can be used) as both “crosslinkers” or “hardener” and “catalyst” or “catalyst package.

Unless otherwise indicated, a reference to a “(meth)acrylate” compound (where “meth” is bracketed) is meant to include both acrylate and methacrylate compounds.

Unless otherwise indicated, all parts, ratios, and percentages are by weight and all molecular weights are number average molecular weight (Mn). Molecular weight may be determined by various techniques well known in the art. With respect to the components and/or compositions described herein, molecular weight, whether described as number average (Mn) or weight average (Mw) molecular weight, is preferably determined by gel permeation chromatography (GPC).

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides a coating composition or coating system for use in and as a high performance insulative and/or protective coating. The coating composition may be applied to a variety of substrates, including but not limited to metal and non-metal materials. The system includes a ring-opening metathesis polymerization (ROMP) component having a combination of cyclic olefins with one or more multi-unsaturated groups and cyclic olefins having at least one mono-unsaturated group. The system further includes at least one metal carbene ROMP catalyst that is a transition metal complex, and also includes a thermal insulative filler dispersed within the ROMP component.

In at least one embodiment, the insulative and/or protective coating system described herein features a ring-opening metathesis polymerization component. By “ring opening metathesis polymerization” or “ROMP” is meant a chain-growth type of polymerization involving metathesis reactions of cyclic olefins like norbornene, cyclopentene, and the like. The reaction can be generally represented as follows:

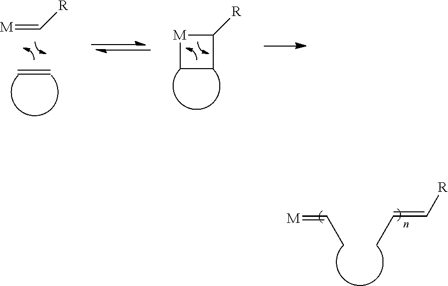

Because the reaction involves a cyclic olefin, the new olefin that is generated by ring-opening and metathesis remains attached to the catalyst and becomes part of a growing polymer chain. Without limiting to theory, the reaction is driven by the relief of strain in the cyclic olefin, and is therefore irreversible. The ROMP polymers typically have a very narrow range of molecular weights that is difficult to achieve by standard polymerization methods. The molecular weight distribution is particularly narrow, i.e. the polydispersity index (Mw/Mn) is typically and preferably in the range of 1.03 to 1.10, i.e. monodisperse. ROMP polymers are known in the art and are substantially as described in U.S. Pat. Nos. 5,342,909; 6,310,121; 6,515,084; 6,525,125; 6,759,537; 7,329,758, etc.

Accordingly, in at least one embodiment, the composition described herein is an insulative and/or protective coating, preferably a hydrophobic coating that also provides corrosion protection, and includes a ROMP component with a combination of cyclic olefin monomers. A first cyclic olefin monomer is multi-unsaturated, i.e. the cyclic olefin is at least bifunctional, meaning that it has at least two, preferably more than two, unsaturated groups. Exemplary multi-unsaturated cyclic olefins of this type include, without limitation, from dicyclopentadiene (DCPD), tricyclopentadiene (TCPD), cyclopentadiene tetramer, cyclopentadiene, 5-vinyl-2-norborene, 5-ethylidene-2-norbornene, 5-isopropenyl-2-norbornene, 5-propenyl-2-norbornene, octadiene, and 5-butenyl-2-norbornene, or mixtures and combinations thereof. In a preferred embodiment, the multi-unsaturated cyclic olefin described herein is dicyclopentadiene.

The multi-unsaturated cyclic olefin monomer is used as part of the ROMP component that makes up the insulative and/or protective coating composition described herein. The amount of the first cyclic olefin is not particularly limited and is chosen based on the desired Tg and other properties and performance characteristics of the ultimate coating composition described herein. Accordingly, in some embodiments, the multi-unsaturated cycloolefin is present as part of the total binder resin, in an amount preferably from 15 to 100 wt % and more preferably 18 to 98% by weight, based on the total weight of the coating composition.

In at least one embodiment, the present description provides an insulative and/or protective coating system that includes a ROMP component with a combination of cyclic olefin monomers. Optionally, the insulative and/or protective coating system described herein may additionally include a cyclic olefin monomer that is mono-unsaturated, i.e. it has one, and preferably no more than one, unsaturated group or moiety. Exemplary mono-unsaturated cyclic olefins include, without limitation, cyclooctene, 5-tolyl-2-norbornene, 5-phenyl-2-norborene, 5-butyl-2-norbornene, 5-hexyl-2-norbornene, 5-octyl-2-norbornene, 5-decyl 2-norbornene, and 5-dodecyl-2-norbornene, or mixtures or combinations thereof. In a preferred embodiment, the mono-unsaturated cyclic olefin monomer is cyclooctene.

The mono-unsaturated cyclic olefin monomer is used as part of the ROMP component that makes up the insulative and/or protective coating composition described herein. The amount of this second cyclic olefin is not particularly limited and is chosen based on the desired Tg and other properties and performance characteristics of the ultimate coating composition described herein. Accordingly, in some embodiments, the mono-unsaturated cycloolefin is present as part of the total binder resin, in an amount preferably from 0.1 to 15% and more preferably 0.5 to 10% by weight, based on the total weight of the coating composition.

In an aspect, the desired Tg of the ROMP component to be used in the coating composition described herein is not so limited, but is preferably higher than the Tg typically seen for conventional epoxy/amine 2K coating systems currently in commercial use in the industry. For example, the Tg of the ROMP component used herein is preferably about 100° C. to 200° C., more preferably about 120° C. to 150° C.

In an embodiment, the coating composition described is an insulative and/or protective coating that includes a ROMP component with a combination of cyclic olefin monomers and a catalyst, preferably a latent catalyst, i.e. a compound that shows no activity at ambient temperatures, but can catalyze a ROMP polymerization reaction when activated. The catalyst is preferably a metal carbene. Without limiting to theory, it is known that the ligand environment of a metal carbene catalyst can affect the polymerization properties (e.g., rate of initiation, rate of propagation, rate of polymerization, initiation rate constant, propagation rate constant (kₚ), initiation rate constant/propagation rate constant ratio (kᵢ/kₚ ratio), rate of viscosity increase, time to 30 cP viscosity, time to hard polymer gel, time to peak exotherm temperature, etc.) of cyclic olefin monomer in a ROMP reaction. A suitable catalyst as described herein is one that initiates ROMP reactions at a rate slow enough to allow control over work time, open time, potlife, and the like. By varying the ligand in the metal carbene catalyst, it is possible to obtain a catalyst that can be used with ROMP reactions while allowing for optimal open time, potlife, and cure characteristics.

In a preferred aspect, the metal carbene catalyst is a transition metal carbene complex, wherein the metal ligand incudes a transition metal of either Group 6 or Group 8. The metal carbene catalyst complex has the general structure as shown below:

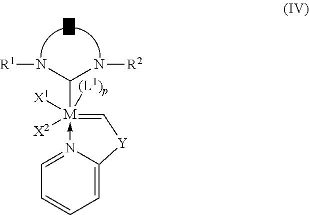

In this general structure,
M is a Group 6 or 8 transition metal;
R1 and R2 are independently selected from hydrogen, hydrocarbyl, substituted hydrocarbyl, heteroatom-containing hydrocarbyl, substituted heteroatom-containing hydrocarbyl, and functional groups;
Q is an organic diradical;
X1 and X2 are anionic ligands, and may be the same or different;
L1 is a neutral electron donor ligand, and p is zero or 1; and
Y is a linkage selected from hydrocarbylene, substituted hydrocarbylene, heteroatom-containing hydrocarbylene, substituted heteroatom-containing hydrocarbylene, —O—, —S—, —NR9-, and —PR9-, wherein R9 is selected from hydrocarbyl, substituted hydrocarbyl, heteroatom-containing hydrocarbyl, and substituted heteroatom-containing hydrocarbyl, as well as isomers thereof.

The transition metal carbene complexes described herein are known to act as catalysts for olefin metathesis and are therefore useful as catalysts for ROMP polymerization. Such catalysts, also known as Grubb's catalysts, are known in the art and commercially available. The use of these catalysts in ROMP polymerization reactions reduces the problems of catalyst functional group tolerance, sensitivity towards air and moisture and degree of polymerization (DP) of macromonomers often seen with conventional catalysts. Suitable catalysts of the type described herein are substantially as described, for example, in U.S. Pat. Nos. 5,312,940; 5,342,909; 5,831,108; 5,969,170; 6,111,121; and 6,211,391; U.S. Patent Pub. No. 20050261451, and various patents and publications referenced therein.

The amount of metal carbene catalyst in the ROMP component as described herein is not particularly limited and is chosen based on the desired reaction properties, pot life, cure and performance characteristics of the ultimate coating composition. Accordingly, in some embodiments, the ROMP catalyst is present in an amount preferably from 0.000001 to 2.5%, preferably 0.0001 to 0.5% by weight, based on the total weight of the coating composition. In an aspect, the catalyst is present as a solution in a liquid carrier, such as water or an organic solvent, for example, in order to dilute the catalyst and also to aid in accurate addition of catalyst.

In an embodiment, the insulative and/or protective coating described herein includes a ROMP component and at least one thermal insulative filler. As used herein, the term “thermal insulative fillers” refers to materials that have relatively low thermal conductivity and reduce or prevent the transmission of heat. Suitable thermal insulative filler materials used in the coating system herein include, for example and without limitation, glass bubbles, polymeric spheres (including microspheres, nanospheres, and the like), hollow ceramic spheres, porous glass, expanded perlite, aerogels, ceramic sphere (including microspheres, nanospheres, and the like), other insulative materials known in the art, and mixtures or combinations thereof.

In an aspect, the thermal insulative filler described herein is dispersed in the coating system, preferably in the ROMP polymer component. The amount of thermal insulative filler dispersed in the system is not particularly limited and is chosen based on the desired thermal insulation properties and performance characteristics of the ultimate coating composition.

Accordingly, in some embodiments, the thermal insulative filler is present in an amount preferably from 0.001 to 50%, preferably 0.1 to 35% by weight, based on the total weight of the coating composition. These fillers typically are very low in density, so while the loading by weight may be small the loading by volume is high. Indeed, in some embodiments, at least part of the thermal insulative filler load may be in the form of trapped/encapsulated gas, such as for example, if/when foam is generated and/or trapped by the coating system. That is, the trapped/encapsulated gas would have little to no mass, but would provide sufficient volume to obtain the necessary insulative properties.

Accordingly, the insulative and/or protective coating system described herein demonstrates low thermal conductivity, preferably up to about 0.2 W/m-K, more preferably up to about 0.12 W/m-K, even more preferably up to 0.09 W/m-K.

In addition to the thermal insulative fillers, in some embodiments, the insulative and/or protective coating described herein includes a ROMP component and at least one barrier filler. As used herein, the term “barrier filler” refers to materials that are used in coatings to form a barrier to moisture and help reduce or inhibit corrosion of a surface or substrate to which the coating is applied. Suitable barrier filler materials used in the coating system herein include, for example and without limitation, glass flake, micaceous iron oxide, FTFE flake, mica, aluminum flake, other barrier filler materials known in the art, and mixtures or combinations thereof. The terms “barrier filler” and “platy filler” are used interchangeably herein.

In an aspect, the barrier filler described herein is dispersed in the coating system, preferably in the ROMP polymer component along with the thermal insulative filler. In another aspect, the barrier filler described herein may be dispersed into the coating system independently of the ROMP polymer component. The amount of barrier filler dispersed in the system is not particularly limited and is chosen based on the desired properties and performance characteristics of the ultimate coating composition and the desired end use of the coating system. Accordingly, in some embodiments, the barrier filler is present in an amount preferably from 0.1 to 30%, preferably 1 to 25% by weight, based on the total weight of the coating composition.

Without limiting to theory, it is believed that a coating system with high levels of filler, preferably greater than about 50 vol %, for example, leads to improved thermal stability, which in turn allows for possible continuous use of a coated substrate or article at temperatures of up to about 400 to 450 F (approximately 204° C. to 232° C.). Accordingly, in an aspect, the combined total volume of both thermal insulative filler and barrier filler in the insulative and/or protective coating system described herein is preferably at least 50 vol %, preferably 50 to 60 vol %.

The use of a ROMP component or polymer in the insulative coating system described herein provides a number of advantages, especially relative to conventional coatings in this area. Most conventional coatings that are currently commercially available are made by reacting a first part A with a second part B. Part A is typically an isocyanate and/or epoxy and part B is typically a polyol and/or amine. Parts A and B react to form a 2K polyurethane or epoxy coating.

In the insulating and/or protective coating system described here, parts A and B of a conventional coating system are replaced with olefin monomers and a polyolefin network is formed with the help of transitional metal carbene complexes as catalysts. Coatings formed in this manner have similar—and sometimes superior—performance characteristics relative to conventional and currently commercially available 2K polyurethane or epoxy coatings. The use of a ROMP polymer component lowers the free monomer concentration and thereby reduces or eliminates isocyanate in the coating system. By optimizing various reaction characteristics (monomers, catalyst, the way components are mixed, and the like), it is possible to push completion of the reaction and extend network formation. As a result, the coating systems described herein exhibit similar properties as conventional epoxy/amine 2K coatings, but with longer potlife and faster cures at a much higher solids content (even 100% solids) with lower or no VOCs. The coating described herein also develops hardness more quickly, such that a substrate with the coating applied thereon can be returned to service more quickly than with conventional 2K coatings that are currently commercially available or otherwise known to those of skill in the art.

The coating compositions described herein may be made by any conventional methods or processes known in the art. Using ROMP chemistry, it is possible to introduce various monomers and polymers that are not conventionally used in coatings. By controlling or optimizing mixing time, quantity and type of monomers, catalyst, and fillers, and by controlling the exotherm, it is possible to obtain a coating system with optimal properties that is a low viscosity liquid coating with high solids, preferably 90 to 100% solids, more preferably even 100% solids.

In the coating system described herein, use of a ROMP polymer component allows for the achievement of several desirable performance outcomes. By careful selection of the multi-unsaturated and mono-unsaturated monomers in the ROMP component, it is possible to achieve high Tg values, preferably as high as 120 to 150° C., resulting in coatings that may be used in higher temperature conditions.

The insulative and/or protective coating system described herein is a hydrophobic system. Hydrophobicity is measured as a function of surface contact angle, and accordingly, in an aspect, the coating system described herein has a surface contact angle of preferably greater than 90°. In another aspect, the coating system described herein has low hysteresis. As used herein, the term “hysteresis” refers to dynamic contact angle hysteresis is a measure of the difference between advancing and receding contact angles of a liquid droplet as it wets out the surface of a substrate to which it is applied, or as measured when the droplet is immersed in a liquid (i.e. water) and then removed. Hysteresis therefore provides a useful measure of the uniformity of a surface coated with a hydrophobic coating (i.e. a coating with surface contact angle of greater than 90°). Lower hysteresis (i.e. a smaller difference between advancing and receding contact angles) implies a more uniform coating with increased hydrophobicity, making the coating system described herein useful as a corrosion protection coating for application in aqueous environments or in environments with prolonged exposure to moisture. For example, the increased hydrophobicity of the coating system means it may be used as a primer composition that is used to lower corrosion when applied to a metal substrate in a wide variety of applications, in some embodiments. In other embodiments, the coating system described herein is used as a topcoat composition, or even as a direct-to-metal coating. Preferably, the coating system described herein forms an integral part of the coating applied to substrates in a wide variety of end uses.

In an embodiment, due to high hydrophobicity and lower hysteresis, the coating system described herein is an ideal candidate for use as a corrosion-under-insulation (CUI) coating, i.e. a coating that prevents corrosion under insulation, a phenomenon involving a severe form of localized, external corrosion that typically occurs on insulated carbon and low alloy steel that are exposed to corrosive aqueous environments. For example, CUI is frequently seen on steel substrates in the offshore and marine/maritime industries, and particularly at higher temperatures. If left undetected, CUI can result in catastrophic leaks or explosions, equipment failure, prolonged downtime for repair or replacement, and safety and environmental concerns. The coating systems described herein are highly hydrophobic and can therefore act as barrier coatings to protect the substrate from moisture and consequent corrosion.

The insulative coating system described herein also demonstrates optimal chemical resistance and corrosion resistance, and therefore, may be applied to a variety of substrates. Accordingly, in an embodiment, the coating system described herein is a hydrophobic and chemical resistant tank lining material. In another embodiment, the coating system described herein is an insulative tank lining material.

In some embodiments, the coating system described herein may be applied to a wide variety of substrates. The substrates are preferably though not exclusively metal substrates, including steel substrates. Suitable substrates to which these coatings can be applied include, for example and without limitation, at least one part of utility poles, ground-embedded structures, above ground structures, pilings for solar panel infrastructure, steel water pipe exteriors, ductile iron pipe exteriors, ductile iron pipe interiors for non-potable liquid, or storage tank exteriors, parts of substrates used for buried services, and the like. Other non-limiting end uses include, for example, fire protection coatings, roof sealings, pool bottoms, water reservoirs, secondary containment coatings, subsea insulation, flooring, corrosion resistant primers, and the like.

In an embodiment, the insulative coating system described herein is a 100% solids system with viscosity of about 2,000 to 70,000 cps (2 to 70 Pa-s), as determined by ASTM D2196-20 (Standard Test Methods for Rheological Properties of Non-Newtonian Materials by Rotational Viscometer). At this viscosity, the binder component or ROMP component of the coating may have higher filler loadings and lead to coatings with better thermal insulation properties relative to conventional 100% solids systems currently in use.

In an embodiment, the insulative coating system described herein is a 100% solids system with density of about 0.1 to 1.0 g/cm³, preferably 0.3 to 0.85 g/cm³. In another aspect, the coating system described herein has a coefficient of thermal expansion (CTE) of less than 5%.

The insulative coating system described herein demonstrates superior adhesion to the substrate relative to other polyolefin coating systems. In an aspect, this is due to the special pretreatments applied to the surface of a given metal substrate. By modifying the functional groups on the monomers used in the ROMP component, it is possible to couple the coating to the substrate surface than other polyolefin networks. Accordingly, in an aspect, the coating system described herein is recoatable, i.e. it can be reapplied without adhesion failure. Where needed, such as for example, with particular substrates that pose adhesion challenges, the coating system described herein may include other additives to further improve adhesion.

In an embodiment, the insulative and/or protective coating system described herein is sprayable. In an aspect, the coating system described herein is applied at a dry film thickness of about 10 to 40 mil (approx. 250 to 1000 μm). Conventionally, high solids polyolefin systems designed using ROMP polymers have not been sprayable due to higher viscosity. Surprisingly, the coating system described herein has lower viscosity of about 2,000 to 70,000 cps (2 to 70 Pa-s) even at 100% solids, allowing the coating to be spray-applied easily on a wide variety of substrates including metal substrates, preferably steel substrates. The substrates may be applied direct to metal (DTM), or on untreated, pretreated, modified or even primed surfaces before the application of the coating composition described herein.

In an embodiment, the coating system described herein is applied to a substrate surface to form an insulative and/or protective film. The dry film thickness (DFT) of these coatings is not particularly limited and is chosen based on the desired properties and performance characteristics of the ultimate coating composition and the desired end use of the coating system. Accordingly, in some embodiments, the coating system has dry film thickness (DFT) of about 1 to 7000 mils (about 25.4 μm to 177.8 mm). In an aspect, where the described coating is used as CUI coating, the DFT is preferably about 5 to 100 mil (about 127 μm to 2.54 mm). In another aspect, the coating has dry film thickness (DFT) of about 10 to 40 mil (about 254 μm to 1.02 mm), where the coating is used as a tank lining. In yet another aspect, where the coating is used as an insulative tank lining, the coating has dry film thickness (DFT) of about 20 to 7000 mil (about 508 μm to 177.8 mm).

Various additives may be included in the coating compositions described herein. Materials that provide a desired effect to the ultimate coating system may be included, such as additives that improve application, adhesion, curing, or ultimate performance or appearance. Examples include, without limitation, reactive diluents, non-reactive diluents, pigments, fillers, cure catalysts, antioxidants, color stabilizers, anti-corrosion additives, degassing additives, flow control agents, adhesion promoters, flexibilizers, toughening agents, and the like, and mixtures or combinations thereof.

The coating compositions and methods described herein may be used with a variety of substrates and/or in a variety of applications or end uses. Typically and preferably, the coating compositions described herein are used to coat metal substrates, including without limitation, unprimed metal, clean-blasted metal, and pretreated metal, including plated substrates and ecoat-treated metal substrates. The metal substrates with the coatings applied thereon may be used in a wide variety of applications including, without limitation, exterior tank linings, insulative (interior) tank linings, exterior and interior pipe linings, insulation coatings, corrosion-under-insulation (CUI) coatings, fire protection coatings, roof sealings, pool bottoms, water reservoirs, secondary containment coatings, subsea insulation, flooring, corrosion resistant primers, and the like.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts, ratios, and percentages are by weight and all molecular weights are number average molecular weight (Mₙ). An exemplary coating composition as described herein may include additional materials in varying concentrations. For example, the composition may further include one or more fillers, wet and dry flow agents, adhesion promoters, rheology additives, degassing agents, and combinations thereof. Unless otherwise specified, all chemicals used are commercially available from, for example, Sigma-Aldrich, St. Louis, Missouri.

### Test Methods

Unless indicated otherwise, the following test methods were utilized in the Examples that follow.

### A. Test for Thermal Conductivity

The thermal conductivity properties of the coating composition described herein was assessed using a standard test, ASTM C518 (Standard Test Method for Steady-State Thermal Transmission Properties by Means of the Heat Flow Meter Apparatus). Briefly, this test measures the rate at which heat flows through a flat specimen mounted on either side of a guarded hot plate. Results for thermal conductivity are reported in units of W/mK and a low value is characteristic of an insulative coating.

### B. Corrosion Under Insulation Testing

The corrosion resistance of a coating under insulation (CUI) as described herein was determined using an industry standard test method, AMPP TM21442 (Standard Practice for Evaluating Protective Coatings for Use Under Insulation). Test samples were coated with the CUI coating followed by a conventional insulation (e.g., mineral wool) and then cladding. Samples are then placed in a trough and cycled through different temperatures with and without water present. Corrosion was monitored using electrochemical methods over a 6-month period.

### C. Thermal Expansion

This is a test that measures the dimensional response to thermal energy, i.e. the test measures the expansion of a coating as the temperature increases. The coefficient of thermal expansion (CTE) of the coatings described herein is typically determined in tension with a 10 g force heated at 3° C./min on a rheometer or rheology instrument, such as the TA Instruments RSA G2 analyzer.

### D. Water Absorption

For the coatings described herein, the ability to take up or absorb as little water as possible after prolonged exposure is indicative of an effective insulative and protective coating. To test, samples were immersed in water for 24 hours at elevated temperature of about 120 F, and results were reported as percent change in weight of the sample. A test sample that demonstrates little weight change after immersion is considered resistant to water absorption.

### E. Viscosity

Viscosity of the coating compositions described herein is determined by standard methods as described in ASTM D2196-20 (Standard Test Methods for Rheological Properties of Non-Newtonian Materials by Rotational Viscometer) using a Brookfield DV-1 viscometer at RV spindle 7 at 50 rpm 25° C.

### Example 1. Preparation of Insulative Coating Composition

Exemplary coating compositions #1 to #5 as described herein were prepared by mixing together components in the amounts (percentage by weight based on the total weight of the composition) as shown in Table 1. The compositions are then applied to test panels and/or free films and assessed for various performance characteristics including corrosion resistance and thermal conductivity. A commercially available acrylic insulative coating is also tested for comparison. Results are as indicated in Table 2.

TABLE 1
Preparation of Insulative Coating Composition

| | | | | | | Commercial |
|---|---|---|---|---|---|---|
| Component | #1 | #2 | #3 | #4 | #5¹ | Coating |
| Cyclic Olefin | 97.7^{a} | 59.7^{a} | 98^{a} | 77.3^{b} | 67.7^{c} | |
| Low TC | 0.9 | | | | | |
| filler 1 | | | | | | |
| Low TC | | 39.2² | | | | |
| filler 2 | | | | | | |
| Low TC | | | | 21.2 | | |
| filler 3 | | | | | | |
| Platy filler | | | | | 27.0 | |
| Other | | | | | 3.3 | |
| additives | | | | | | |
| Catalyst | 2.0 | 1.1 | 2.0 | 1.5 | 2.0 | |
| solution | | | | | | |

^{a}Proxima R6400 (EXP1961-NI) cyclic olefin obtained from Materia Inc., Pasadena, CA
^{b}Proxima R6200 (EXP1992-NI) cyclic olefin obtained from Materia Inc., Pasadena, CA
^{c}Proxima R6400/R6200 cyclic olefin obtained from Materia Inc., Pasadena, CA
¹Composition #5 outperformed commercially available epoxy-based CUI coatings when tested to AMPP TM 21442 with LPR monitoring.
²Composition #2 demonstrated no blistering at 60 days when tested to NAC TM-0174 Procedure A/ASTM C868 with deionized water to 100° C., with similar results observed when the low thermal conductivity filler was replaced with a barrier filler.

TABLE 2
Performance Characteristics of Insulative Coating

| | | | | | | Commercial |
|---|---|---|---|---|---|---|
| Component | #1 | #2 | #3 | #4 | #5 | coating |
| Density | 0.39 | 0.59 | 1.11 | 0.67 | 1.27 | |
| (g/mL) | | | | | | |
| Thermal | 0.051 | 0.091 | 0.12 | 0.084 | | 0.095 |
| conductivity | | | | | | |
| (W/mK) | | | | | | |
| Water | 0.4 | 0.4 | 0.0 | 0.1 | | 11 |
| absorption | | | | | | |
| (% weight | | | | | | |
| change) | | | | | | |

### Example 2. Preparation of Corrosion Under Insulation Coating

A corrosion under insulation coating is prepared by mixing together components in the amounts (percentage by weight based on the total weight of the composition) as shown in Table 3. The composition is then applied by spraying onto a test panel. This composition meets the standards required by AMPP TM 21442 (data not shown).

TABLE 3
Corrosion under Insulation Coating

| Components | Composition #1 |
|---|---|
| Mixture of mono- and multi- | 69.0 |
| saturated cyclic monomers | |
| ROMP catalyst solution | 1.4 |
| Filler | 27.3 |
| Additives | 2.3 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. An insulative coating system, comprising:
a ring-opening metathesis polymerization (ROMP) component comprising
at least one cyclic olefin having one or more multi-unsaturated groups;
optionally, at least one cyclic olefin having at least one monounsaturated group; and
at least one metal carbene ROMP catalyst, wherein said catalyst is a transition metal complex; and
a thermal insulative filler dispersed within the ROMP component.

2. (canceled)

3. (canceled)

4. The coating system of claim 1, wherein the coating is sprayable.

5. The coating system of claim 1, wherein the catalyst is a Group 8 transitional metal complex.

6. The coating system of claim 1, wherein the catalyst is a Group 6 transitional metal complex.

7. The coating system of claim 1, wherein the at least one cyclic olefin having one or more multi-unsaturated groups is present in amount of about 18 to 98 wt % based on the total weight of the coating.

8. The coating system of claim 1, wherein the at least one cyclic olefin having at least one monounsaturated group is present in an amount of about 0.5 to 10 wt % based on the total weight of the coating.

9. The coating system claim 1, wherein the metal carbene ROMP catalyst is present in an amount of about 0.0001 to 1 wt % based on the total weight of the coating.

10. The coating system of claim 1, wherein the thermal insulative filler is present in an amount of about 0.001 wt % to 35 wt % based on the total weight of the coating.

11. The coating system of claim 1, further comprising one or more non-reactive diluents.

12. The coating system of claim 1, wherein the coating is about 90 to 100% solids.

13. The coating system of claim 1, wherein the coating has a viscosity of about 2 to 70 Pa-s.

14. The coating system of claim 1, wherein the coating demonstrates water absorption of up to about 2.0 wt % with a receding contact angle greater than 50°.

15. The coating system of claim 1, wherein the coating has dry film thickness (DFT) of about 1 to 7000 mils (about 25.4 μm to 177.8 mm).

16. (canceled)

17. The coating system of claim 1, wherein the coating has thermal conductivity of up to about 0.12 W/m-K.

18. (canceled)

19. The coating system of claim 1, wherein the coating has a coefficient of thermal expansion (CTE) of less than 5%.

20-23. (canceled)

24. The coating system of claim 1, wherein the coating is a corrosion-under-insulation coating.

25-27. (canceled)

28. A coated article, comprising:
a substrate; and
the coating system of claim 1 disposed on at least one surface of the substrate.

29. The coated article of claim 28, wherein the coating is a corrosion-under-insulation coating, a tank lining, or an insulative tank lining.

30. A method of coating a substrate, comprising:
providing a substrate;
contacting at least one surface of the substrate with the coating system of claim 1; and
subjecting the substrate surface in contact with the coating system of any of the above claims to conditions effective to promote a ROMP reaction in the presence of the ROMP catalyst to form a ROMP matrix as a coating on the substrate surface.

31. (canceled)

32. The method of claim 30, wherein the substrate forms at least part of a utility pole, tank lining, insulative tank lining, or pilings on solar panel infrastructure.

33-42. (canceled)
